(19) United States
(12) Patent Application Publication
(10) Pub. No.: US 2024/0204300 A1
(43) Pub. Date: Jun. 20, 2024

(54) POWER STORAGE DEVICE

(71) Applicants: TOYOTA JIDOSHA KABUSHIKI KAISHA, Toyota-shi (JP); SUBARU CORPORATION, Tokyo (JP)

(72) Inventors: Shigeyuki INOUE, Toyota-shi (JP); Tatsuma YAHARA, Seto-shi (JP); Yasuhiro SEKIYA, Tokyo-to (JP)

(73) Assignees: TOYOTA JIDOSHA KABUSHIKI KAISHA, Toyota-shi (JP); SUBARU CORPORATION, Tokyo (JP)

(21) Appl. No.: 18/505,296

(22) Filed: Nov. 9, 2023

(30) Foreign Application Priority Data
Dec. 20, 2022 (JP) 2022-203383

(51) Int. Cl. H01M 10/658; H01M 10/613; H01M 10/656; H01M 50/209; H01M 50/367

(52) U.S. Cl. CPC H01M 10/658; H01M 10/613; H01M 10/656; H01M 50/209; H01M 50/367

(57) ABSTRACT

A power storage device includes: a housing case having an installation area in which a plurality of power storage stacks can be installed; one or more power storage stacks that are disposed in the installation area in a manner that an extra region is formed in the installation area, in which extra region at least one power storage stack can be installed; a cooler for cooling the installation area; and an insulator member for inhibiting inside the housing case from being cooled by the cooler, the insulator member being disposed within the housing case, wherein the one or more power storage stacks each include a plurality of power storage cells, each power storage cell being provided with an exhaust for exhausting a gas from the power storage cell, the insulator member is installed in the extra region, and the housing case includes a pressure relief valve above the insulator member.

### CROSS REFERENCE TO RELATED APPLICATIONS

This nonprovisional application is based on Japanese Patent Application No. 2022-203383 filed on Dec. 20, 2022 with the Japan Patent Office, the entire content of which is hereby incorporated by reference.

### BACKGROUND

### Field

The present disclosure relates to a power storage device.

### Description of the Background Art

Japanese Patent Laying-Open No. 2022-154741 discloses a conventional power storage device that has a configuration for inhibiting supercooling of cell stacks (power storage stacks), the power storage device comprising a housing case accommodating multiple cell stacks and a blower for cooling the cell stacks with an airspace between the cell stacks and the blower, the housing case including: an inner cooling fin disposed on the inner surface of a bottom wall of the housing case; and an outer cooling fin disposed on the outer surface of the bottom wall. The blower is configured to stop when the battery temperature is lower than a threshold. This allows the battery to be cooled by air, while inhibiting supercooling of the battery when the outdoor air temperature is low.

### SUMMARY

Depending on a vehicle type or a required travel distance, the number of power storage stacks accommodated in a same housing case of the power storage device may be adjusted. For example, if the number of power storage stacks accommodated is reduced, a space is formed in a region where no power storage stack is installed. In such a case, if the entirety of the region where a maximum number of power storage stacks are installed is cooled by a cooler, the air in the housing case, warmed up by the heat generated by the power storage stacks, is cooled due to that space, arousing a concern that condensation may occur in the region where no power storage stack is installed.

Furthermore, if a gas is produced when the power storage cells included in the power storage stack generate heat and no measure is taken against it, debris contained in the gas, such as a metallic foreign object, may adhere to the power storage stack and cause the power storage stack to short out.

The present disclosure is made in view of the above problem. An object of the present disclosure is to provide a power storage device that can inhibit a power storage stack from shorting out when a gas is produced by generation of heat of the power storage cell, while inhibiting condensation from occurring.

A power storage device according to the present disclosure includes: a housing case having an installation area in which a plurality of power storage stacks can be installed; one or more power storage stacks that are disposed in the installation area in a manner that an extra region is formed in the installation area, in which extra region at least one power storage stack can be installed; a cooler for cooling the installation area; and an insulator member for inhibiting inside the housing case from being cooled by the cooler, the insulator member being disposed within the housing case, wherein the one or more power storage stacks each include a plurality of power storage cells, each power storage cell being provided with an exhaust for exhausting a gas from the power storage cell, the insulator member is installed in the extra region, and the housing case includes a pressure relief valve above the insulator member.

According to the above configuration, since the insulator member is disposed in the extra region, of the installation area, where no power storage stack is disposed, the space, in the installation area, where no power storage stack is disposed, can be inhibited from being cooled by the cooler. This can inhibit the air in the space warmed up by the power storage stack from being cooled, thereby inhibiting condensation from occurring.

Moreover, since the pressure relief valve is disposed above the insulator member, if a gas is produced from the power storage cell, the debris contained in the gas, such as a metallic foreign object, can be collected to the insulator member side. This can inhibit the debris from adhering to the power storage stack and causing the power storage stack to short out.

In the power storage device according to the present disclosure, the cooler may be disposed below the housing case. The insulator member may include an open space that opens toward the pressure relief valve, and an airspace. In this case, the airspace may be disposed closer to the cooler than the open space is.

According to the above configuration, since the airspace is provided closer to the cooler within the insulator member, the thermal insulating performance of the insulator member can further be enhanced. In addition, since the open space that opens toward the pressure relief valve is provided, the debris can be collected at the open space.

In the power storage device according to the present disclosure, the one or more power storage stacks and the insulator member may be aligned in a first direction in the installation area. The insulator member may be disposed at an outermost end of the first direction.

According to the above configuration, the debris can be collected to the outermost end of the first direction. This can further inhibit the debris from adhering to the power storage stack and causing the power storage stack to short out, compared to the insulator member being disposed in part way through the first direction.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a cross-sectional view of a power storage device according to an embodiment.

FIG. 2 is a plan view of the power storage device according to the embodiment, with an upper case of a housing case removed.

FIG. 3 is an enlarged cross-sectional view of the surroundings of an insulator member included in the power storage device according to the embodiment.

### DESCRIPTION OF THE PREFERRED EMBODIMENTS

Hereinafter, an embodiment according to the present disclosure will be described, with reference to the accompanying drawings. Note that the embodiment below uses the same reference signs to refer to the same or common parts, and description thereof will not be repeated.

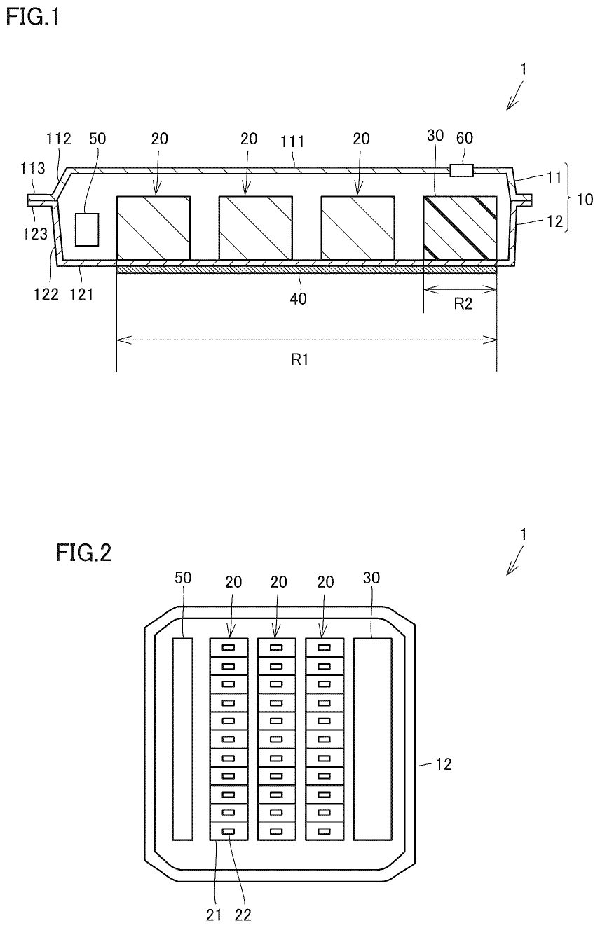

FIG. 1 is a cross-sectional view of a power storage device according to the embodiment. FIG. 2 is a plan view of the power storage device according to the embodiment, with the upper case of the housing case removed. Referring to FIGS. 1 and 2, a power storage device 1 according to the embodiment is now described.

The power storage device 1 is mounted on a hybrid electric vehicle capable of traveling using a mechanical power of at least one of the motor or the engine, or an electric-powered vehicle that travels using a driving force obtained from electrical energy.

The power storage device 1 includes a housing case 10, multiple power storage stacks 20, an insulator member 30, a cooler 40, and an electronic apparatus 50.

The housing case 10 accommodates the power storage stacks 20, the insulator member 30, and the electronic apparatus 50 therein. The housing case 10 includes an upper case 11 and a lower case 12. The upper case 11 constitutes the upper portion of the housing case 10.

The upper case 11 is provided with a pressure relief valve 60. More specifically, the pressure relief valve 60 is disposed above an insulator member 30 described below. The pressure relief valve 60 opens when the pressure in the housing case 10 is greater than or equal to a predetermined pressure, and allows a gas within the housing case 10 to exhaust through the pressure relief valve 60.

The upper case 11 has a generally box shape that opens downward. The upper case 11 has a ceiling portion 111, a surrounding wall portion 112, and a flange portion 113. The surrounding wall portion 112 extends from the peripheral edge of the ceiling portion 111. The flange portion 113 extends outward from the lower end of the surrounding wall portion 112.

The lower case 12 has a generally box shape that opens upward. The lower case 12 has a bottom 121, a surrounding wall portion 122, and a flange portion 123. The bottom 121 is disposed opposite the ceiling portion 111. The surrounding wall portion 122 extends upward from the peripheral edge of the bottom 121. The flange portion 123 extends outward from the upper end of the surrounding wall portion 122.

The flange portion 113 and the flange portion 123 are fastened together by multiple fastener members, with the lower surface of the flange portion 113 and the upper surface of the flange portion 123 mating together. This couples the upper case 11 and the lower case 12.

The housing case 10 has an installation area R1 in which multiple power storage stacks 20 can be installed. The installation area R1 is a region where a maximum number of power storage stacks 20 can be installed. In the present embodiment, three power storage stacks 20 are disposed in the installation area R1. However, the installation area R1 allows, for example, up to four power storage stacks 20 to be installed therein.

The number of power storage stacks 20 that can be installed in the installation area R1 is not limited to four, and two, three, or five or more power storage stacks 20 may be installed therein.

The power storage stacks 20 are installed in the installation area R1 in a manner that an extra region R2 is formed in the installation area R1, in which extra region R2 at least one power storage stack 20 can be installed. In the present embodiment, the extra region R2 is configured so that one power storage stack 20 can be installed therein. However, two or more power storage stacks 20 may be installed in the extra region R2. An insulator member 30 described below is installed in the extra region R2.

The power storage stack 20 includes multiple power storage cells 21 that are aligned in a predetermined arrangement direction. For example, the arrangement direction is parallel to the width direction of the vehicle with the power storage device 1 being mounted on the vehicle. The power storage cells 21 each include an exhaust 22 for exhausting a gas from the power storage cell 21.

The power storage cell 21 is, for example, a secondary battery such as a nickel-hydrogen battery or a lithium-ion battery. The power storage cell 21 has a rectangular shape, for example. The secondary battery may be one using liquid electrolyte or one using a solid electrolyte.

The power storage stacks 20 are disposed spaced apart from each other in a first direction orthogonal to the arrangement direction. For example, the first direction is parallel to the front-rear direction of the vehicle with the power storage stacks 20 mounted thereon.

The power storage stacks 20 are disposed thermally in contact with the inner surface of the bottom 121 of the housing case 10. For example, the power storage stacks 20 are secured to the inner surface of the bottom 121 by an adhesive having thermal conductivity.

The power storage stacks 20 and the insulator member 30 are aligned in the first direction. The insulator member 30 is disposed at an outermost end of the first direction in the installation area R1. For example, a foamed resin can be employed as the insulator member 30. The insulator member 30 has a generally parallelepiped shape. The insulator member 30 has a shape generally similar to the power storage stack 20.

The cooler 40 is disposed for cooling the installation area R1. The cooler 40 is disposed below the housing case 10. The cooler 40 is secured to the outer surface of the bottom 121 of the housing case 10 by an adhesive having thermal conductivity, for example.

The cooler 40 is disposed in a manner that permits, for example, a refrigerant to flow therethrough. The cooler 40 cools the power storage stacks 20 disposed in the installation area R1 by permitting the refrigerant to flow through the cooler 40.

The electronic apparatus 50 controls the power storage stacks 20. The electronic apparatus 50 is a cell ECU, for example. The electronic apparatus 50 is located opposite the insulator member 30 in the first direction. In other words, one or more power storage stacks 20 are disposed between the electronic apparatus 50 and the insulator member 30.

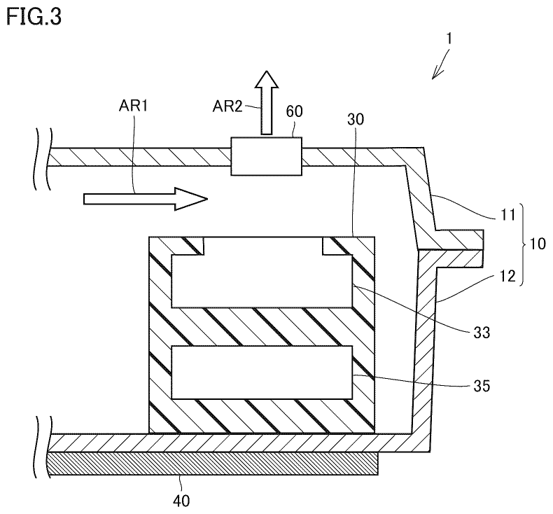

FIG. 3 is an enlarged cross-sectional view of the surroundings of the insulator member in the power storage device according to the embodiment.

The insulator member 30 includes an open space 33 and an airspace 35. The open space 33 opens toward the pressure relief valve 60. The airspace 35 is provided below the open space 33, that is, closer to the cooler 40 than the open space 33 is.

Here, if the power storage cells 21 included in any of the power storage stacks 20 generates heat due to abnormal operation, a gas is exhausted through the exhaust 22. This builds up the pressure in the housing case 10. As the pressure in the housing case is greater than or equal to a predetermined pressure, the pressure relief valve 60 opens and a gas within the housing case 10 is exhausted through the pressure relief valve 60.

In other words, the gas exhausted through the exhaust 22 advances toward the pressure relief valve 60 disposed above the insulator member 30 as indicated by the arrow AR1 in the figure, and is exhausted through the pressure relief valve 60 to the housing case 10 side as indicated by the arrow AR2 in the figure.

The gas exhausted through the exhaust 22 is hot, and includes debris such as a metallic foreign object. The pressure relief valve 60 is disposed above the insulator member 30 to guide the flow of gas toward the insulator member 30 side, thereby collecting the debris on the insulator member 30 side. This can inhibit the debris from adhering to the power storage stack 20 and causing the power storage stack to short out.

At this time, since the insulator member 30 is disposed at an outermost end of the first direction in which the power storage stacks 20 and the insulator member 30 are aligned, the debris can be collected to the outermost end of the first direction (in particular, to the side away from the electronic apparatus 50 side). This can inhibit the debris from adhering to the electronic apparatus 50 and causing the electronic apparatus 50 to short out. This can further inhibit the debris from adhering to the power storage stack 20, as compared to a configuration in which the insulator member 30 is disposed in part way through the first direction and the power storage stacks 20 are disposed on both sides of the insulator member 30.

In addition, since the insulator member 30 has the open space 33 that opens toward the pressure relief valve 60, the debris can be collected at the open space 33.

Moreover, since the insulator member 30 is disposed in the extra region R2, of the installation area R1, where no power storage stack 20 is disposed, the space in the extra region R2 can be inhibited from being cooled by the cooler 40. This can inhibit the air in the space warmed up by the power storage stacks 20 from being cooled, thereby inhibiting condensation from occurring. Furthermore, since the airspace 35 is provided close to the cooler 40 in the insulator member 30, the thermal insulating performance can further be enhanced.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A power storage device, comprising:
a housing case having an installation area in which a plurality of power storage stacks can be installed;
one or more power storage stacks that are disposed in the installation area in a manner that an extra region is formed in the installation area, in which extra region at least one power storage stack can be installed;
a cooler for cooling the installation area; and
an insulator member for inhibiting inside the housing case from being cooled by the cooler, the insulator member being disposed within the housing case, wherein
the one or more power storage stacks each include a plurality of power storage cells, each power storage cell being provided with an exhaust for exhausting a gas from the power storage cell,
the insulator member is installed in the extra region, and
the housing case includes a pressure relief valve above the insulator member.

2. The power storage device according to claim 1, wherein
the cooler is disposed below the housing case,
the insulator member includes an open space that opens toward the pressure relief valve, and an airspace, and
the airspace is provided closer to the cooler than the open space is.

3. The power storage device according to claim 1, wherein
the one or more power storage stacks and the insulator member are aligned in a first direction in the installation area, and
the insulator member is disposed at an outermost end of the first direction.
